(19) United States
(12) Patent Application Publication
(10) Pub. No.: US 2026/0126020 A1
(43) Pub. Date: May 7, 2026

(54) INJECTOR FOR INJECTING GAS

(71) Applicant: LIEBHERR-COMPONENTS DEGGENDORF GMBH, Deggendorf (DE)

(72) Inventor: Martin SEIDL, Deggendorf (DE)

(21) Appl. No.: 18/706,342

(22) PCT Filed: Nov. 4, 2022
(86) PCT No.: PCT/EP2022/080787

§ 371 Date: Apr. 30, 2024

(30) Foreign Application Priority Data
Nov. 8, 2021 (DE) 10 2021 128 957.2

(51) Int. Cl. F02M 21/02; F02M 61/08

(52) U.S. Cl. CPC F02M 21/0206; F02M 21/0254; F02M 21/0263; F02M 61/08; F02M 2200/9015

(57) ABSTRACT

The present invention relates to an injector for injecting gas, preferably for directly injecting hydrogen, comprising a fuel feed line for introducing a gaseous fuel which is under high pressure, an actively switchable active valve, preferably an active solenoid valve, which is designed to take up a closing or a releasing state in order either to permit or to interrupt a flow connection from the fuel feed line to a region downstream of the active valve, and a passive valve which is arranged downstream of the active valve and is passively switchable by different pressure ratios prevailing upstream and downstream into a closing or releasing state and/or can be brought into a closing or releasing state by contact with a movable part of the active valve. In a closed state of the active valve, at least one sealing surface of the active valve is sealed.

The present invention relates to an injector for injecting a gas such as hydrogen, preferably for directly injecting hydrogen.

In the wake of ever stricter exhaust emission limits worldwide and ambitious climate protection targets, the environmental requirements for combustion engines are constantly increasing. The aim in the foreseeable future is to achieve low-emission or even emission-free drive technologies that meet even the strictest exhaust emission limits and make a significant contribution to achieving climate protection targets. For technologies that work with combustion, these targets can only be achieved by using climate-neutral, regeneratively produced fuels that do not cause any emissions along the entire value chain (so-called “zero emissions” fuels).

With current conventional petrol, diesel and gas engines, the requirements for emission-free combustion-even when using so-called e-fuels, e.g. a synthetically produced OME fuel that only requires renewable energy for its production-cannot be achieved, as the emission of harmful exhaust gases such as nitrogen oxides (NOx), unburned hydrocarbons (UHC) and soot cannot be completely reduced with current technologies.

In principle, battery-powered drives comply with the Zero Emissions Directive during operation and are gaining ground in the passenger car sector in particular. However, if the entire value chain is considered, the production of (lithium) batteries is very costly in terms of energy and problematic from an environmental point of view, as the extraction of raw materials is particularly damaging to the environment and the extraction of the raw materials required for the batteries cannot be carried out sustainably. In addition, the power-to-weight ratio of batteries currently achievable means that they cannot be used in machines with high (peak) power requirements.

Fuel cell-powered drives with a supply of regeneratively produced hydrogen meet the specified climate protection targets and are already in use today to a very limited extent. However, this concept also has some disadvantages, such as low peak power and low economic efficiency compared to today's diesel drives.

The focus has therefore shifted to hydrogen combustion engines, which represent a promising alternative drive system. To date, however, these exist almost exclusively in very small numbers or as demonstrators with a low degree of maturity. Hydrogen produced from renewable energies would meet all the requirements of “zero emission”, as it can be burned without emissions.

In the passenger car sector, for example, there are hydrogen engines with external mixture formation (PFI=port fuel injection), in which the fuel is thoroughly mixed with air in sufficient time before entering the combustion chamber. Hydrogen engines with direct injection of the fuel into the combustion chamber (DI=direct injection) play practically no role today, but compared to the PFI concept, they offer higher efficiency, more stable combustion and elimination of the risk of re-ignition in the intake tract.

In direct-injection hydrogen engines, a distinction is typically made with regard to the maximum injection pressure in the injector (<60 bar: low pressure, >60 bar: high pressure), whereby the limits are not clearly defined and the transitions are fluid. Higher pressures offer the potential of a shortened injection duration in a later phase of compression at higher combustion chamber pressures, which results in increased efficiency and improved combustion stability. However, the overall efficiency decreases if compression of the hydrogen is required beforehand.

It is the object of the present invention to provide an injector for injecting gas such as hydrogen, which is simple in its structure and robust against faults. In addition, the injector according to the invention should also be capable of injecting a gas, for example hydrogen, directly into a combustion chamber cooperating with the injector. Similar to fuel injectors for diesel and gasoline, it is necessary for gas to be injected into a combustion chamber in a certain quantity and a certain concentration in a timed manner.

If the hydrogen is obtained 100% from renewable energies, hydrogen combustion engines can be operated in an almost climate-neutral manner. There are also numerous other advantages:
Use of known technologies with a high degree of maturity and existing production facilities.
Unlimited availability of hydrogen through electrolysis of water
Use of the existing filling station system possible (after appropriate conversion) with fast refueling times
(Almost) emission-free conversion of hydrogen in combustion possible, as C02-neutral, only minimal CO, UHC, particulate and soot emissions (only caused by lubricants in the feed system, below the measurement limit) and only minimal NOx emissions due to suitable combustion process (possibly with exhaust gas recirculation, SCR catalytic converter)·
Significantly lower hydrogen purity requirements compared to fuel cell drives
no need for platinum for production as with fuel cells

In addition to these numerous advantages over other drive concepts, however, there are also a number of challenges that need to be overcome in the development of hydrogen combustion engines:
low molecular weight of hydrogen, resulting in a low density combined with a low volumetric energy density (with a high mass-specific energy density); see table 1.
Provision of a correspondingly high volume flow when injecting hydrogen.
Corresponding provision of large flow cross-sections in the injector and therefore significantly larger actuator strokes required than with conventional drive types
Tightness of the overall system/prevention of external leaks, especially with regard to safety aspects (risk of fire and explosion due to hydrogen escaping from the system).
Increased risk of wear on guides of moving components due to the virtually non-existent lubricating effect of hydrogen
Significantly greater tendency of moving components to bounce on mechanical stops in gas injectors compared to injectors with liquid fuels due to low damping effect during gas compression.
Material resistance to hydrogen necessary with regard to the risk of hydrogen embrittlement in mechanically stressed/pressurized components (reduced strength) or due to chemical reaction of the hydrogen with oxygen present in the copper coil of the actuator (hydrogen sickness of the copper).
Mixture preparation in the combustion chamber/Influence on the injection jet/Ignition behavior with low volume injection

TABLE 1
Mass and volume-specific calorific value of diesel and hydrogen

| | Diesel | Hydrogen (at 25° C.) |
|---|---|---|
| Calorific value in | 1143.0 | 11120.0 |
| MJ/kg | | |
| Calorific value in | 35′819 | 9.8 at 1 bar |
| MJ/m³ | | 287.7 at 30 bar |
| | | 2464.4 at 300 bar |

It is the object of the present invention to at least partially overcome or mitigate the disadvantages listed above. This is achieved by means of an injector for injecting gas which comprises all the features of claim 1. Advantageous embodiments of the injector are specified in the dependent claims.

According to the invention, it is provided that the injector for injecting gas, preferably for directly injecting hydrogen, comprises a fuel feed line for introducing a gaseous fuel which is under high pressure, an actively switchable active valve, preferably an active solenoid valve, which is configured to be in a closing state or a releasing state, to optionally permit or interrupt a flow connection from the fuel feed line to an area downstream of the active valve, and a passive valve which is arranged downstream of the active valve and can be passively switched into a closing state or releasing state by different pressure conditions prevailing upstream and downstream and/or can be brought into a closing state or releasing state by contact with a movable part of the active valve. The injector according to the invention is preferably further developed in that, in a closed state of the active valve, at least one sealing surface of the active valve is sealed by an elastic sealing element, preferably an elastomer, preferably by means of a metal elastomer seal.

In the case of injectors known from the prior art, it is not possible to ensure that the injector is as close to 100% leakproof as possible against the escape of hydrogen (into the combustion chamber) with a pure metal-to-metal seal that is typically used. In contrast, the present invention uses at least one sealing connection with a soft-elastic part (e.g. metal-elastomer seal), which can adapt to the surface of the counterpart due to its deformability, and thus represents a safe and reliable possibility of (almost) 100% sealing (only a minimal, practically irrelevant leakage cannot be prevented).

To date, however, it has not been possible to use an elastic sealing element in an injector, as elastic sealing elements, in particular elastomer compounds, can only withstand permanent loads up to temperatures of approx. 200° C. and therefore suffer damage due to the significantly higher temperature load from the combustion chamber and can no longer fulfill their sealing function.

In order to protect the sealing point of the active valve with the elastomer from excessive temperature stress, the invention provides for the use of a downstream passive valve in the injector, which keeps the hot exhaust gases/gases away from the active valve.

The simultaneous use of the passive valve together with an elastic sealing element in the active valve creates a synergistic effect that significantly improves the injector. Finally, with the injector according to the invention it is possible to use a previously unusable elastic seal, in particular an elastomer, to seal a valve in the injector, which has excellent stability, whereby the injector is significantly improved with regard to the tightness of a gaseous fuel.

According to an advantageous embodiment of the present invention, it may be provided that a sealing surface of the passive valve is sealed by a rigid sealing element, preferably a metal, preferably in a metal-to-metal seal. The passive valve is arranged downstream of the active valve and is therefore closer to the combustion chamber. As a result, it has to withstand more adverse conditions and is exposed, among other things, to the hot exhaust gases produced during combustion in the combustion chamber. For this reason, it is advantageous if the passive valve creates a seal using a non-elastic sealing element, for example a sealing element made of metal, which can be part of a metal-to-metal seal. A rigid sealing element, for example implemented by a metal, is more resistant to the adverse conditions.

According to a further optional embodiment of the present invention, it may be provided that the active valve comprises an armature which is movable in the longitudinal direction of the injector and which is movable out of its rest position in dependence on a magnetizable coil, so as to urge a valve needle out of its closed position, preferably the injector further comprising a valve spring for urging the valve needle into its closed position.

In a rest position, the armature is arranged in such a way that the valve needle of the active valve closes a passage of the valve. If, on the other hand, the armature is moved from its rest position, this causes the valve needle to lift from its closed position so that the active valve is opened. To move the armature, a magnetizable coil is typically used, which generates a magnetic field in a current-carrying state that moves the armature out of its rest position. The movement of the armature then causes the valve needle to lift out of its closed position, resulting in a flow connection between areas upstream and downstream of the active valve.

In order to return the active valve to its closed position after deactivating the actuator, which can be implemented in the form of the coil, for example, a valve spring can be provided to urge the valve needle into its closed position. It can also be provided that the restoring force emanating from the valve spring is used to move the armature into its initial position.

According to a further optional modification of the present invention, it may be provided that the injector further comprises a valve needle counterpart which is rigidly arranged in the injector and which serves for selectively placing a valve needle in order to close at least one opening present in the valve needle counterpart, wherein preferably in a placed-on state of the valve needle at least one resilient sealing element is arranged in the intermediate space between the valve needle counterpart and the valve needle, which sealing element seals the at least one opening.

It can therefore be provided that the valve needle, in conjunction with a valve needle counterpart, optionally closes or opens a passage for the flow of gaseous fuel. It may be provided that both the valve needle and the valve needle counterpart comprise apertures or openings extending in the direction of flow, wherein a flow connection from openings of the valve needle to openings of the valve needle counterpart is interrupted when the valve needle is placed on the valve needle counterpart. This scaling is improved by the provision of at least one clastic sealing element between the contact surfaces of the valve needle and the valve needle counterpart, so that this leads to an improved tightness of the active valve.

Furthermore, it may be provided that the valve needle counterpart is arranged upstream of the movable valve needle, wherein preferably a component of the armature element of the active valve, in particular a rod-like armature part, extends through an opening of the valve needle counterpart in order to contact the valve needle arranged on the downstream side of the valve needle counterpart and in particular to urge it into a releasing position.

Typically, the arrangement of the valve needle and the valve needle counterpart is the other way round, but requires a larger installation space for the injector.

With the present arrangement, in which the movable valve needle is arranged downstream of the valve needle counterpart, i.e. closer to the combustion chamber than the valve needle counterpart, a more compact design can be achieved. In order to transmit a movement of the armature to the valve needle, it can be provided that the armature comprises at least one rod-like element which pushes through an opening of the valve needle counterpart permanently arranged in the injector in order to urge the valve needle into an open position against the closing force impressed by the valve spring.

A further advantage of this arrangement with a valve needle arranged downstream of the valve needle counterpart is the lower actuator force that must be applied by the armature to open the valve needle from its closed position. This means that the highly pressurized gaseous fuel that is fed into the injector from the fuel feed line acts in the opening direction of the valve needle, so that a lower overall force is sufficient to open the valve needle.

According to an optional embodiment of the invention, it may be provided that a valve spring for urging the valve needle into its closed position is arranged on the side of the valve needle facing away from the valve needle counterpart and is preferably arranged downstream of the valve needle.

The concept of a valve needle that opens outwards, i.e. towards the combustion chamber, also allows the valve spring to be arranged in an area downstream of the valve needle.

According to a further advantageous modification of the present invention, it may be provided that the passive valve is arranged downstream of the valve needle, which is urged into its closing position in the direction of the valve needle via a passive valve spring element. An insert of the passive valve is configured in such a way that a high pressure originating from the combustion chamber presses the insert of the passive valve into its closing position. A passive valve spring is also provided for this purpose, which also pushes the insert into its closing position. To open the passive valve or to lift the insert of the passive valve out of its closed position, it may be sufficient if the highly pressurized gaseous fuel introduced via the fuel feed line acts on the insert of the passive valve via the open active valve. Pressure conditions can occur such that the insert of the passive valve is forced out of its closed position with simultaneous compression of the passive valve spring, so that gaseous fuel flows out of the injector.

According to a further advantageous modification of the present invention, it may be provided that when the active valve is actuated, which leads to the valve needle being moved into the open position, the opening movement of the valve needle exerts a mechanical force on the passive valve to transfer it into the open position, preferably by means of a rod-like element arranged on the valve needle, on a passive valve insert or on a rod-like element arranged between the valve needle (9) and the passive valve insert (15).

In addition to “passive” opening of the passive valve, which is achieved solely by applying pressure differences to the passive valve, the movement of the valve needle of the active valve can also be used to apply a mechanical force to the passive valve in the opening direction. As a result, the passive valve or its insert is then not opened solely due to a pressure difference applied, but due to a combination of the pressure difference applied together with a mechanical force acting on the insert of the passive valve. For example, the movement of the valve needle can be used to lift the insert of the passive valve, which is pushed in the same direction into the open position, out of its closed position. A rod-like element can be provided to transmit the mechanical force, which transmits the movement of the valve needle to the insert of the passive valve. This rod-like element can be fixed to the insert of the passive valve, fixed to the valve needle or freely movable between the valve needle and the insert of the passive valve.

In purely passive operation of the passive valve, which is initially closed, the initial pressure build-up upstream of the passive valve (in the valve chamber) causes a very strong acceleration of the passive valve insert. This can lead to wear and component damage due to the high mechanical load. A combined active-passive control, in which both a pressure difference and a mechanical force act on the passive valve insert, causes the passive valve to open even before an overpressure is created in the valve chamber that opens the passive valve. This significantly reduces the acceleration of the passive valve insert and thus the mechanical load.

According to a further advantageous modification of the present invention, it may be provided that in a closed position of the active valve as well as the passive valve, a gap is formed between the side of the valve needle facing the passive valve and the side of the passive valve facing the valve needle, this gap being dimensioned such that it is closed when the active valve is actuated, which leads to a movement of the valve needle into the open position, so that after this gap is closed by continuing the opening movement of the valve needle, a mechanical force is exerted on the passive valve to transfer it into the open position.

In the present case, although the movement of the valve needle is used to transmit a corresponding force to the insert of the passive valve or to the rod-like element transmitting the force transmission, the valve needle is not connected to the insert of the passive valve or the rod-like element in its closed position, but there is a gap between them. This gap is preferably dimensioned in such a way that it is closed when the valve needle moves completely into its open position in order to transmit a mechanical force to open the passive valve before the valve needle reaches its maximum open position. One advantage of this is that the valve needle can thus absorb sufficient momentum to force the insert of the passive valve out of its closed position with high force, which ensures an (advantageous) steeper increase in the outflow rate of the gaseous fuel from the injector. The maximum outflow volume of the injector is therefore available more quickly.

Furthermore, it can be advantageously provided that an elastic intermediate piece is arranged in the gap in order to dampen the force acting on the passive valve. In addition, this intermediate piece also has a positive effect when the passive valve insert is returned to the closed position, as bouncing is also dampened.

According to a further optional embodiment of the present invention, it may be provided that in a closed position of the active valve, the armature urging the valve needle out of its closed position is spaced apart from the valve needle, preferably in order to absorb a certain acceleration before contacting the valve needle during an opening process.

Similar to the gap between the rod-like element or the insert of the passive valve and the valve needle, a gap can also be provided between the armature and the valve needle. In this way, the armature or the rod-shaped element accelerated by it can receive sufficient speed to then urge the valve needle out of its closed position with high energy. The high impact impulse helps to overcome a high closing force, which is advantageous for safe operation of the injector.

Furthermore, according to the present invention, it may be provided that the valve needle counterpart is arranged in a fixed position in the injector and/or comprises at least one opening for the gaseous fuel to pass through.

In addition, according to the present invention, it may be provided that the valve needle is arranged so as to be movable in the longitudinal direction of the injector and/or comprises at least one opening for passing the gaseous fuel through.

Both the valve needle and the valve needle counterpart can essentially have the shape of a plate, which has at least one feedthrough that connects the two flat sides of the plate-like shape to each other. Advantageously, the basic shape of the valve needle or the valve needle counterpart is circular, so that they can be inserted into a cylindrical injector housing and their outer circumference is flush with the inside of the injector housing or attached to it.

According to a further optional modification of the present invention, it may be provided that the valve needle and/or the valve needle counterpart comprises at least one resilient sealing element on the side facing the valve needle counterpart or the valve needle, in order to seal at least one opening (passage) of the valve needle counterpart for passing the gaseous fuel from the at least one opening (passage) of the valve needle for passing the gaseous fuel in a pressed-together state.

According to the invention, it can also be provided that the coil, which is provided for actuating the armature of the active valve, is arranged outside an injector housing. The coil is located completely outside the housing and thus has no contact with the gaseous fuel, in particular hydrogen, which prevents penetration into the copper wire and thus its damage over its service life.

Furthermore, it may be provided that the active valve is advantageously configured in such a way that a valve spring prevents unintentional opening of the valve needle and thus the escape of fuel/penetration of air/exhaust gas/fuel gas into the injector in any case, e.g. due to the high combustion chamber pressure. By sealing the passive valve against the combustion chamber pressure, the valve spring cannot be as strong in certain versions, which means that less magnetic force is required to open the valve needle.

Advantageously, the gaseous fuel can be guided through the entire injector in such a way that the flow always extends inside or outside the compression springs. This means that the flow does not pass through the coils of the compression springs.

The invention also relates to a method for operating an injector, in particular for operating an injector according to any one of the preceding variants, wherein during injection a sound passage occurs at least one point in the injector in order to achieve decoupling from the combustion chamber to the injector, so that the injection rate is independent of the combustion chamber back pressure, the sound passage preferably occurring at the at least one opening in the valve needle counterpart and/or at the at least one opening in the valve needle, which represent(s) throttling surfaces limiting the flow of the gaseous fuel.

Other line sections in the injector that restrict the cross-section are much larger than the cross-section of the at least one opening in the valve needle or the valve needle counterpart. Advantageously, the cross-section of the other openings is more than 50%, preferably more than 100%, larger than the at least one opening in the valve needle or the at least one opening in the valve needle counterpart.

By reaching the supersonic in the injector, there is a decoupling of the combustion chamber from the injector, whereby the injection rate is independent of the combustion chamber back pressure.

Furthermore, the invention also relates to an internal combustion engine with direct gas injection, in particular with direct hydrogen injection, comprising an injector according to any one of the variants described above or an internal combustion engine which is operated using the above method.

Further features, details and advantages of the invention will become apparent from the following description of the figures. The Figures show in:

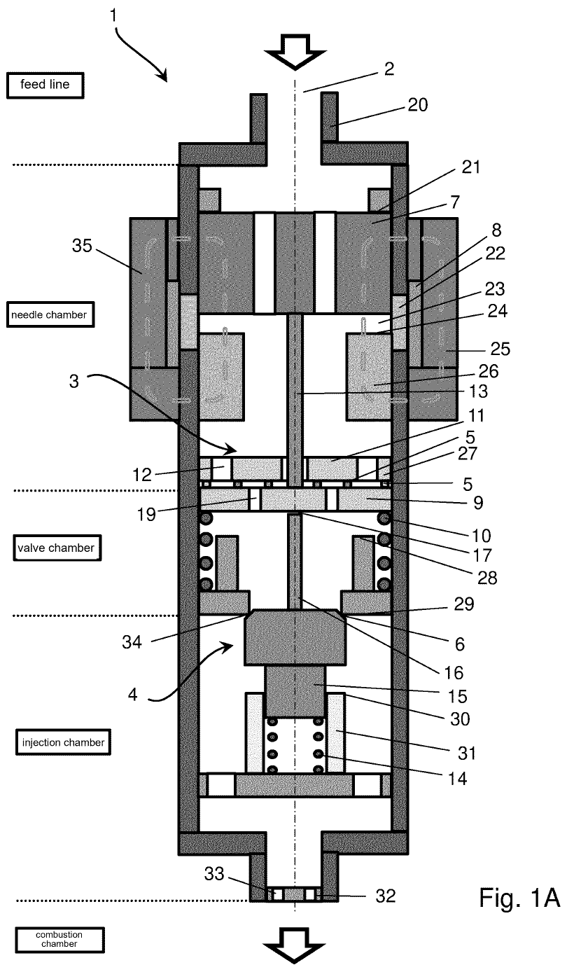

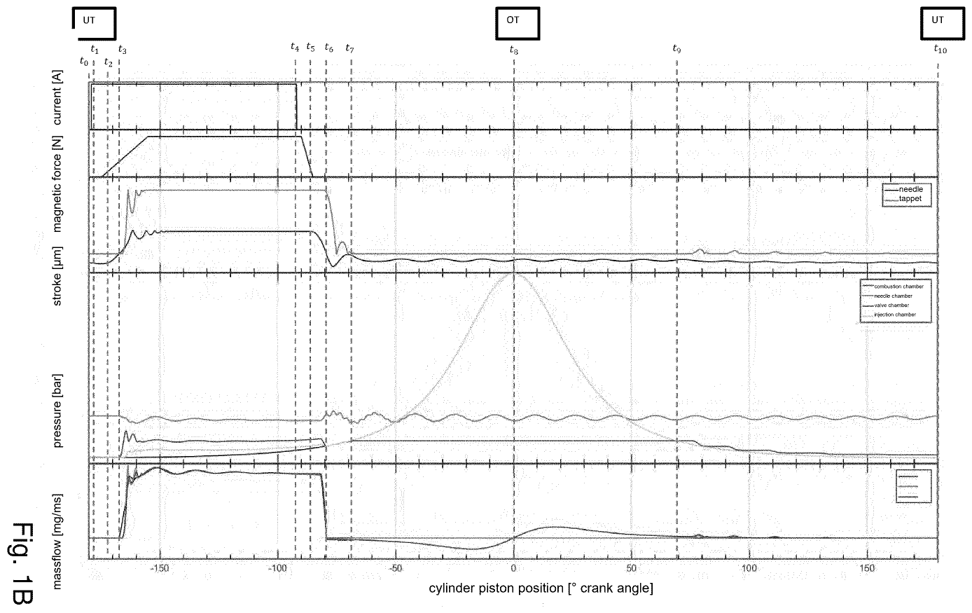

FIG. 1A: a schematic sectional view through an injector according to the invention,

FIG. 1B: diagrams of the basic behavior of the injector during injection,

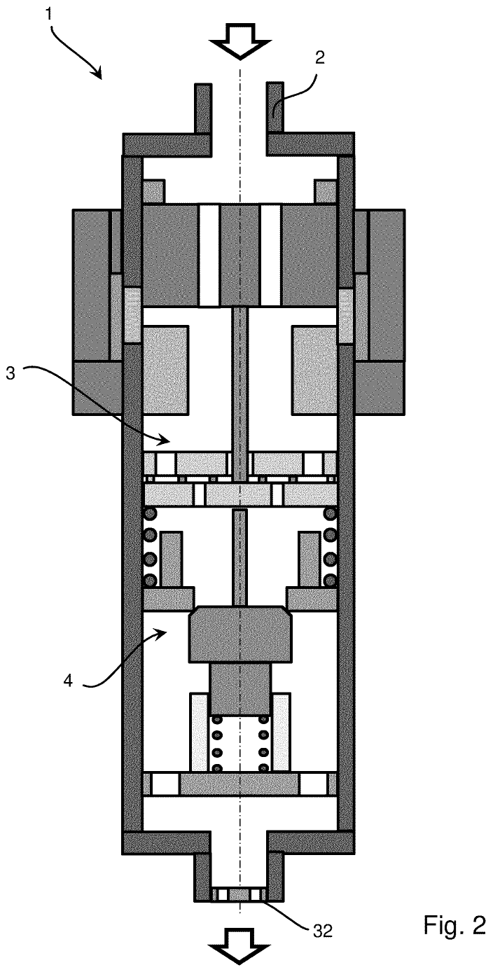

FIG. 2: a schematic sectional view of the injector according to the invention in an initial state with closed valves,

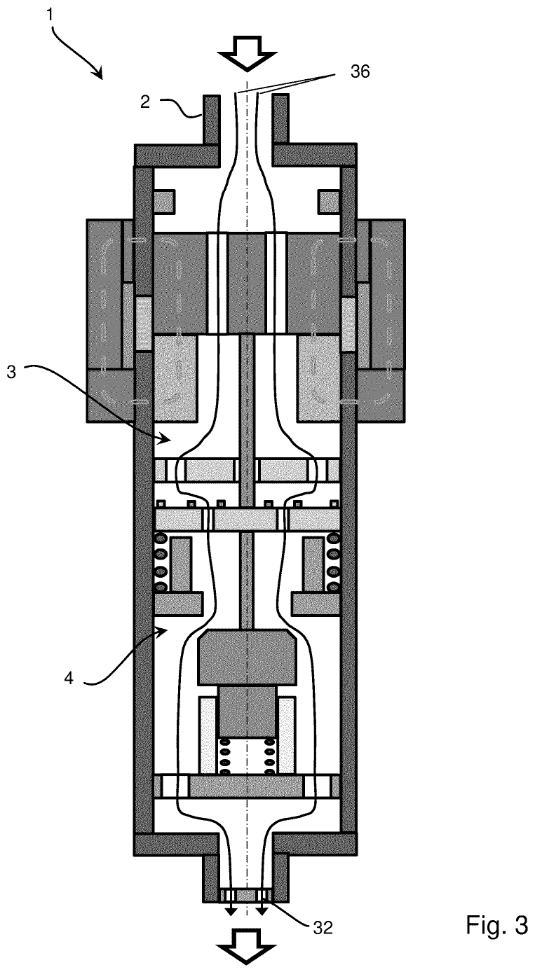

FIG. 3: a schematic sectional view of the injector according to the invention in an open state with the valves open,

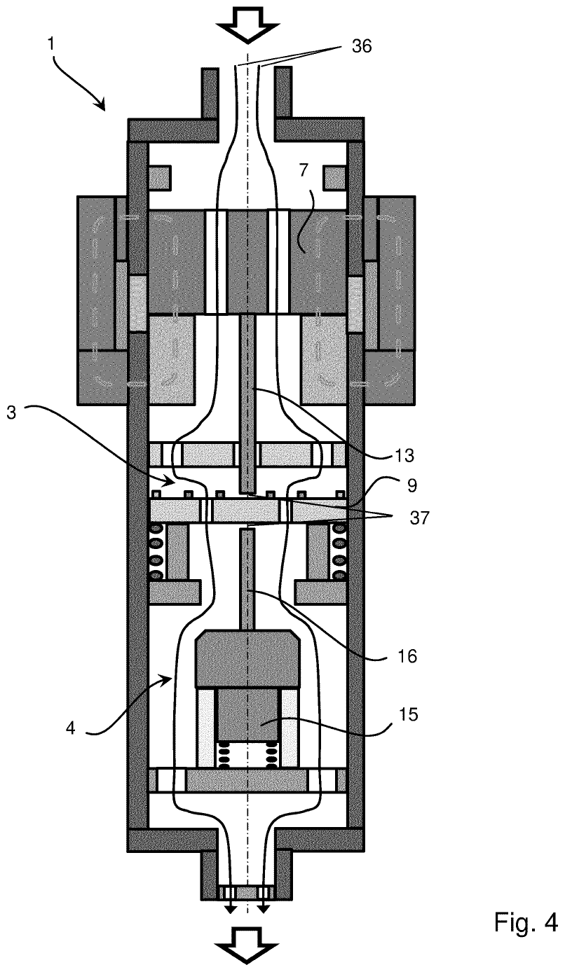

FIG. 4: a schematic sectional view of the injector according to the invention in an open state with open valves and a respective gap between the valve needle and armature rod as well as between the valve needle and the insert of the passive valve,

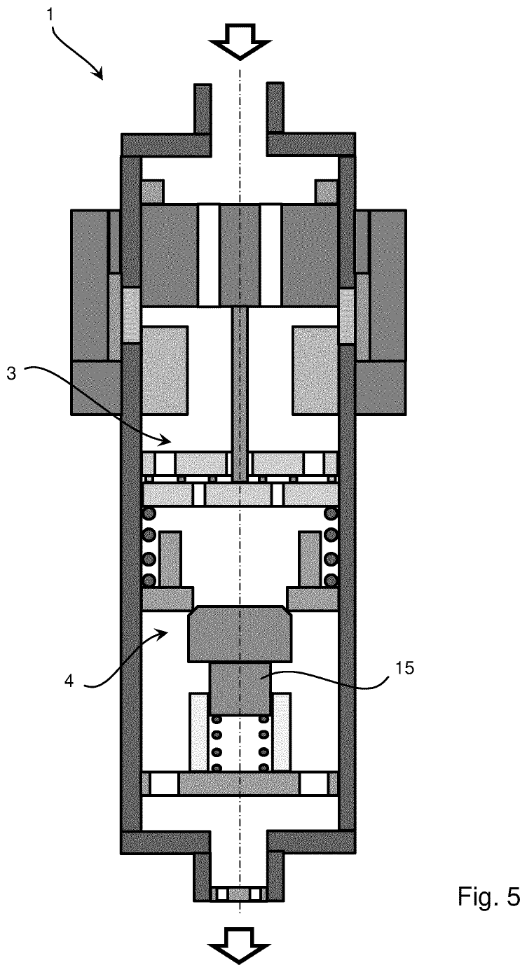

FIG. 5: a schematic sectional view of the injector according to the invention according to a further embodiment without passive valve rod,

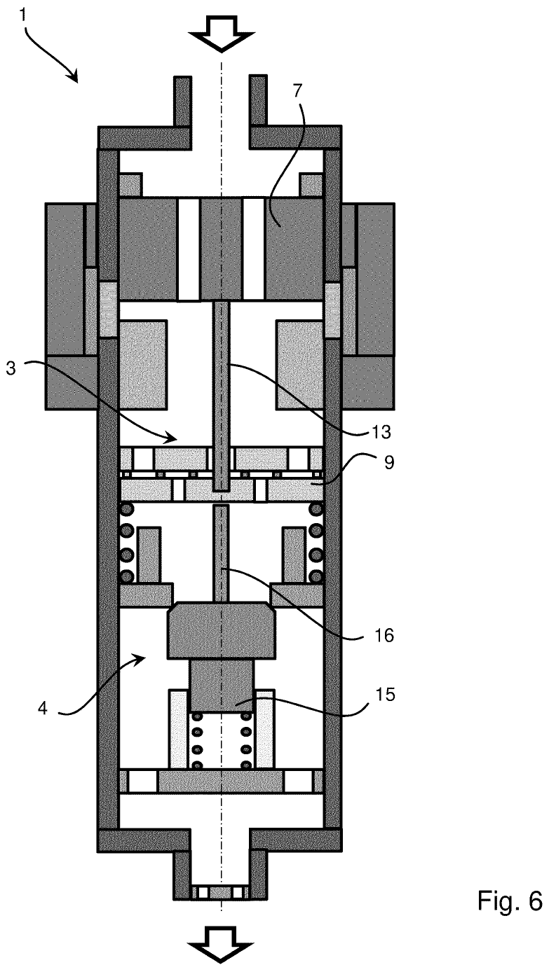

FIG. 6: a schematic sectional view of the injector according to the invention according to a further embodiment, in which the armature is connected directly to the valve needle via the armature rod,

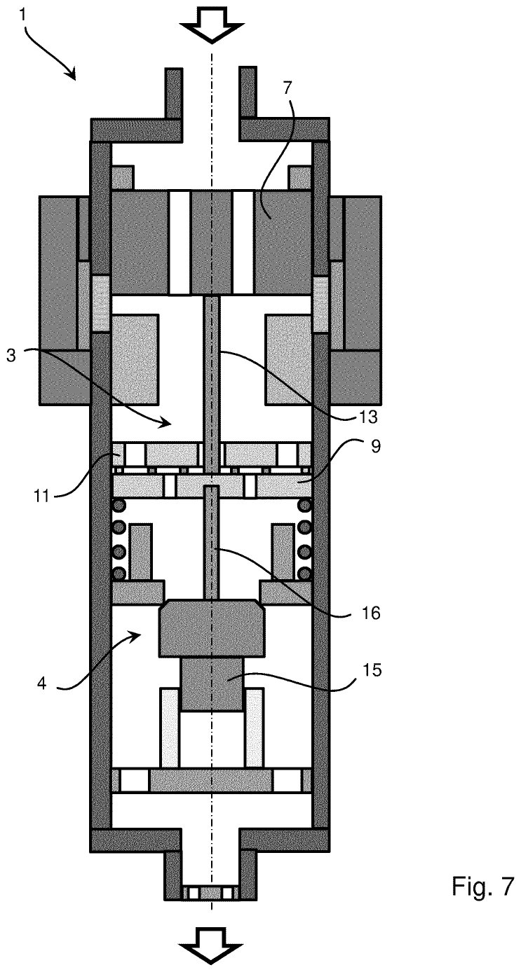

FIG. 7: a schematic sectional view of the injector according to the invention according to a further embodiment, in which the valve needle is connected directly to the insert of the passive valve via a rod-like element,

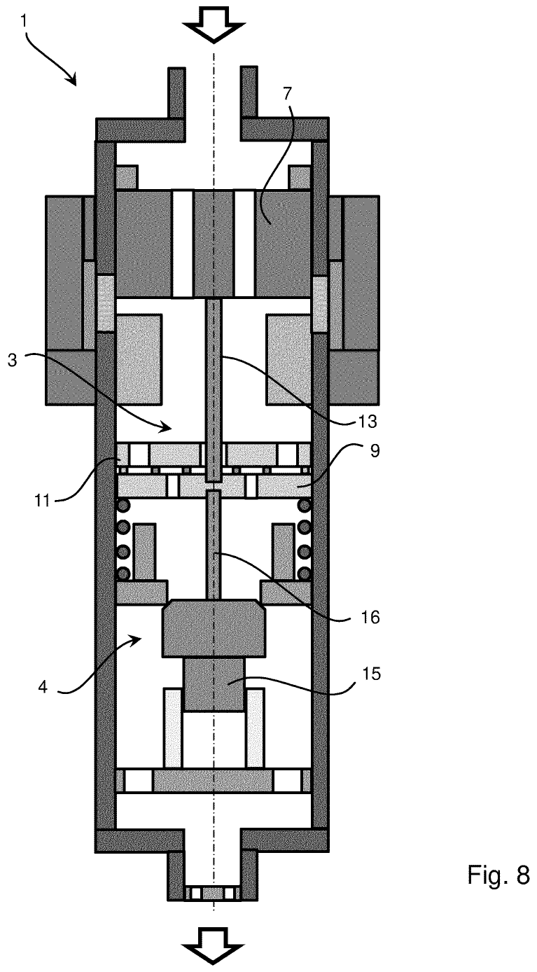

FIG. 8: a schematic sectional view of the injector according to the invention according to a further embodiment, in which the valve needle is connected to both the insert of the passive valve and the armature rod,

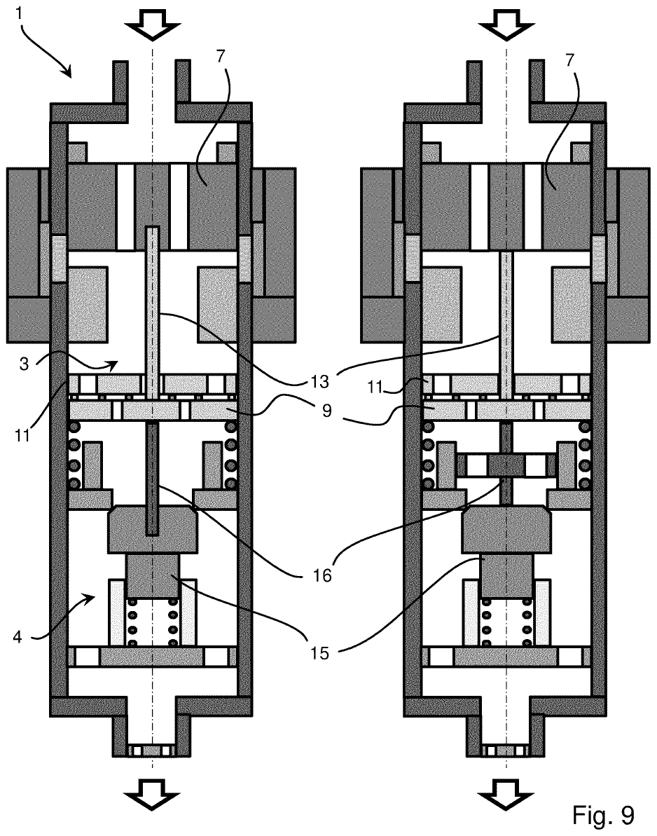

FIG. 9: Two schematic sectional views, arranged side by side, of the injector according to the invention according to a respective further embodiment, in which the rod-like elements are connected or not connected,

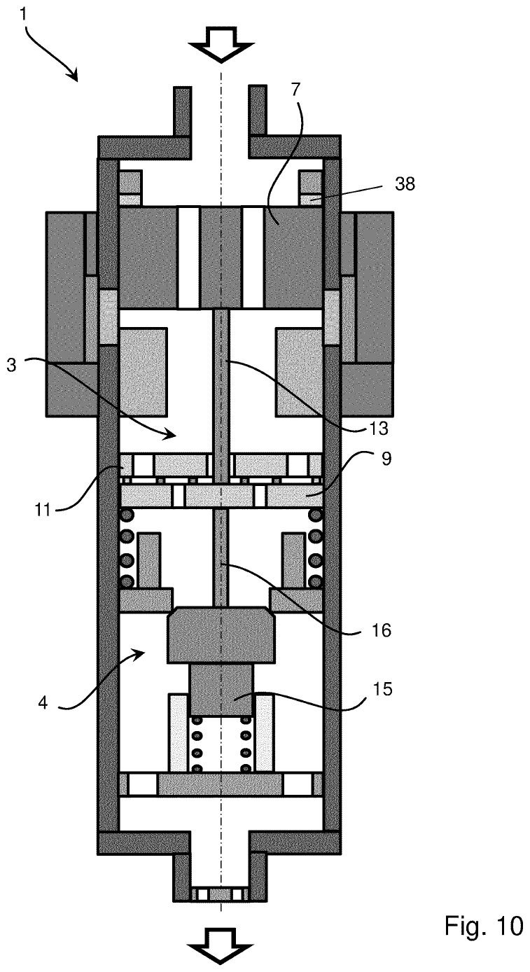

FIG. 10: a schematic sectional view of the injector according to the invention according to a further embodiment, in which tolerance compensation is achieved by an elastic stop of the armature,

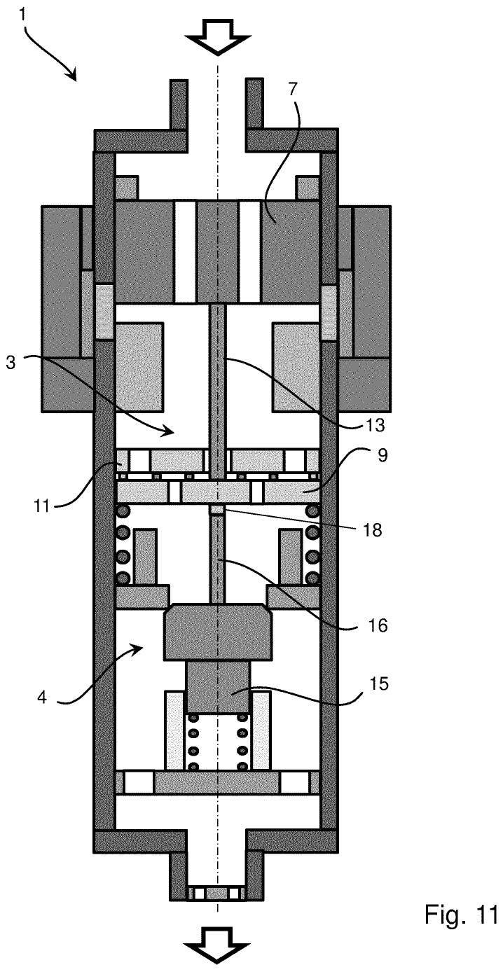

FIG. 11: a schematic sectional view of the injector according to the invention according to a further embodiment, in which tolerance compensation is achieved by means of an elastic intermediate piece between the insert of the passive valve and the valve needle,

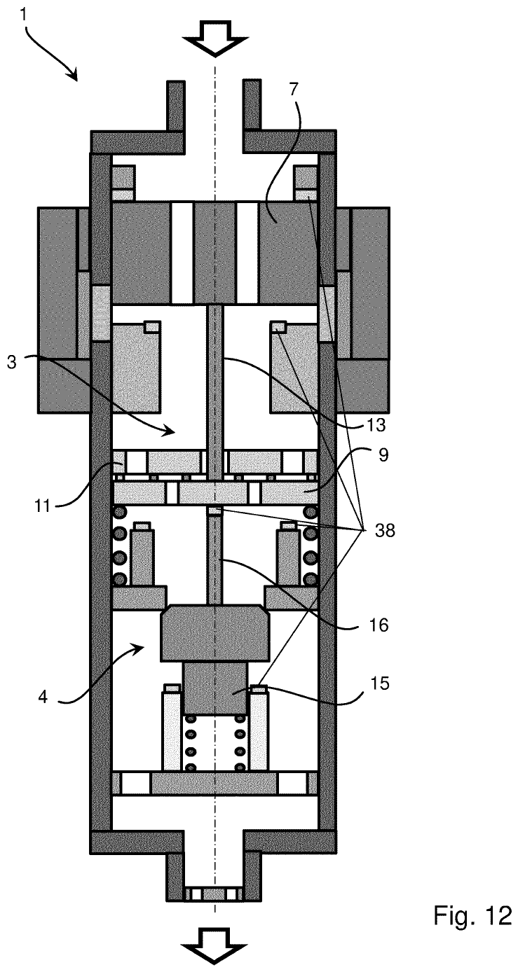

FIG. 12: a schematic sectional view of the injector according to the invention according to a further embodiment, in which elastic damping elements are provided to reduce or prevent bouncing,

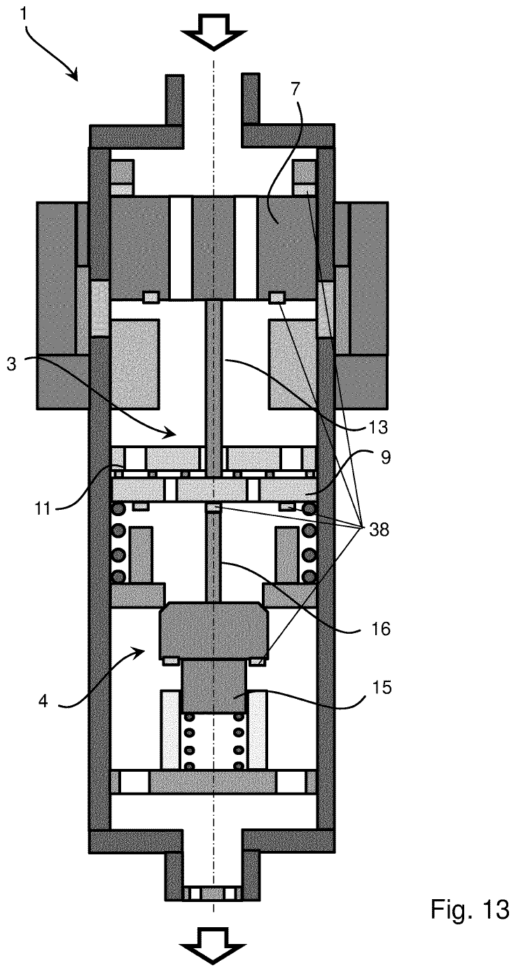

FIG. 13: a schematic sectional view of the injector according to the invention according to a further embodiment, in which elastic damping elements are provided to reduce or prevent bouncing,

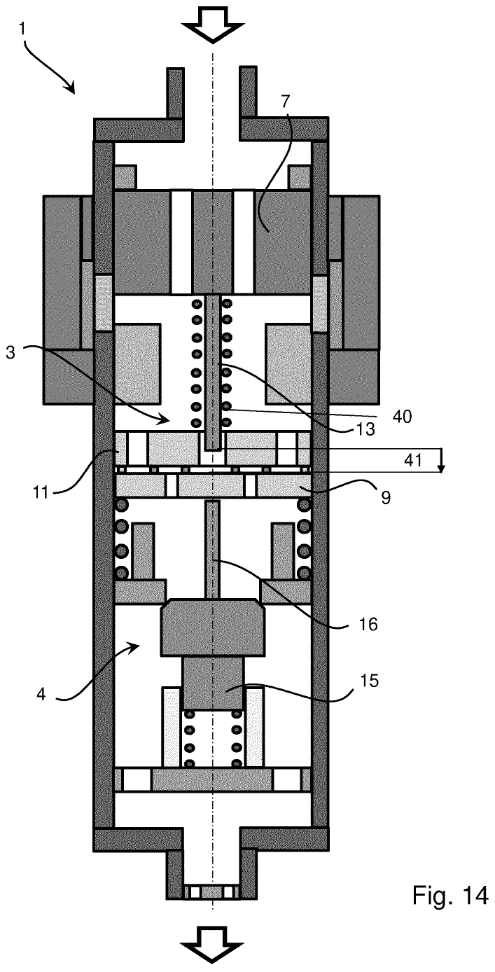

FIG. 14: a schematic sectional view of the injector according to the invention according to a further embodiment, in which the armature has no contact with the valve needle in a closed position of the active valve

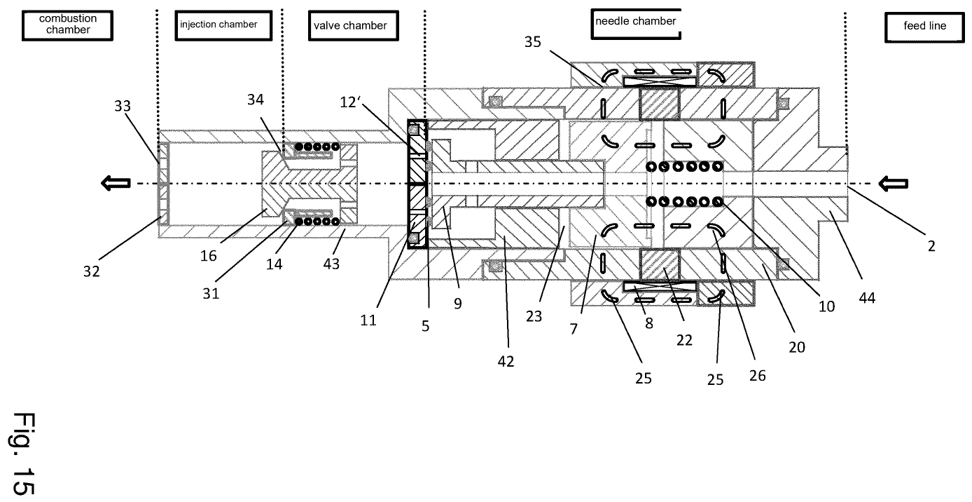

FIG. 15: a schematic sectional view of the injector according to the invention according to a further embodiment with an opening movement of the valve needle which is directed against the direction of flow of the gaseous fuel,

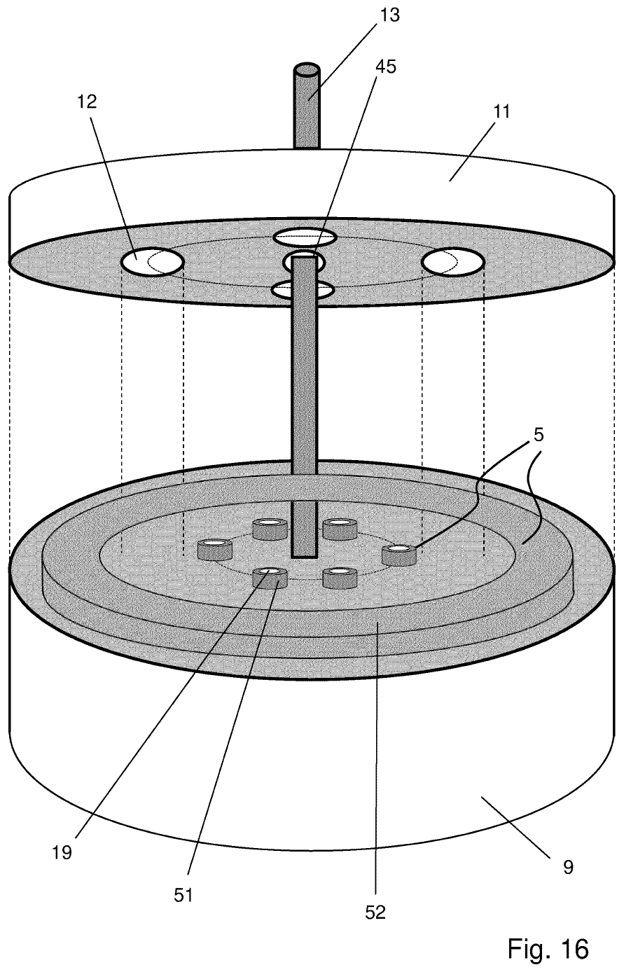

FIG. 16: a perspective view of a sealing point of the active valve according to a first embodiment

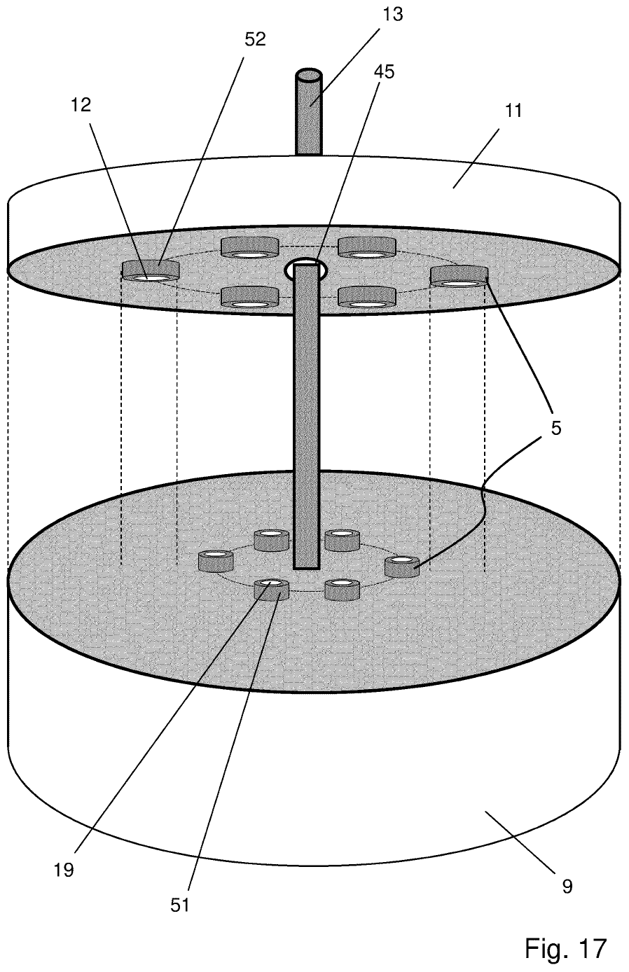

FIG. 17: a perspective view of a sealing point of the active valve according to a further embodiment,

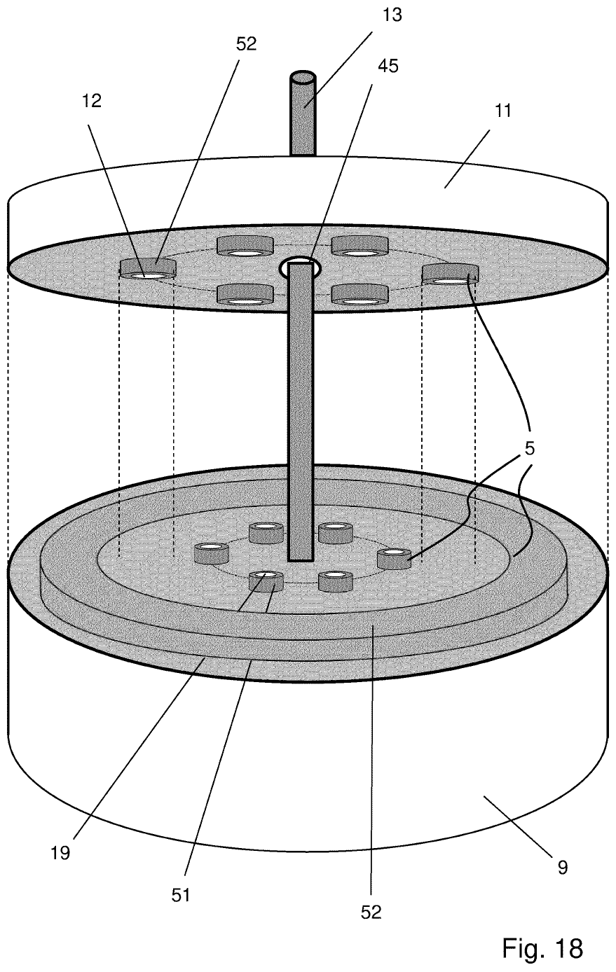

FIG. 18: a perspective view of a sealing point of the active valve according to a further embodiment,

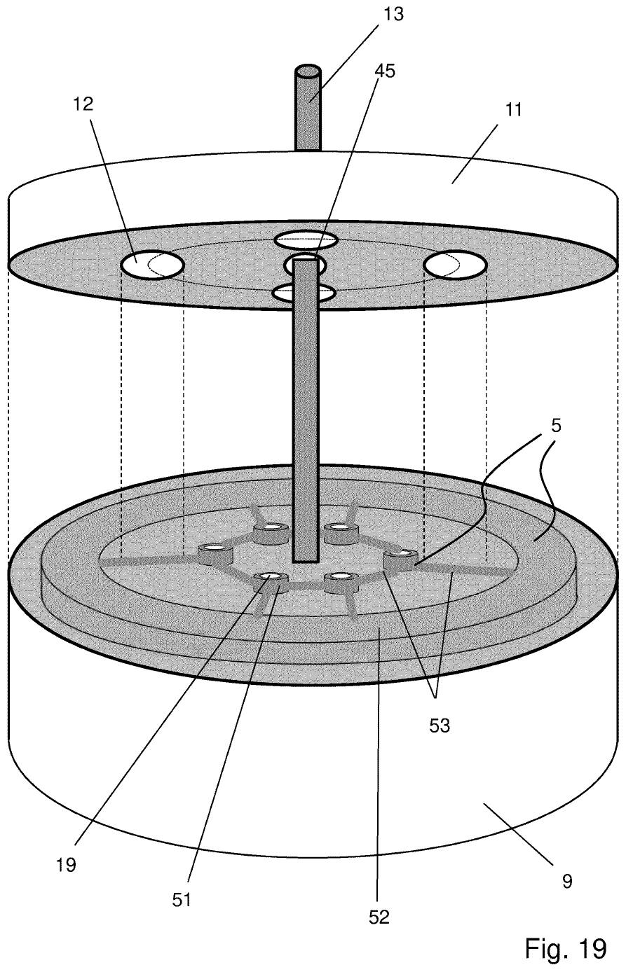

FIG. 19: a perspective view of a sealing point of the active valve according to a further embodiment, and

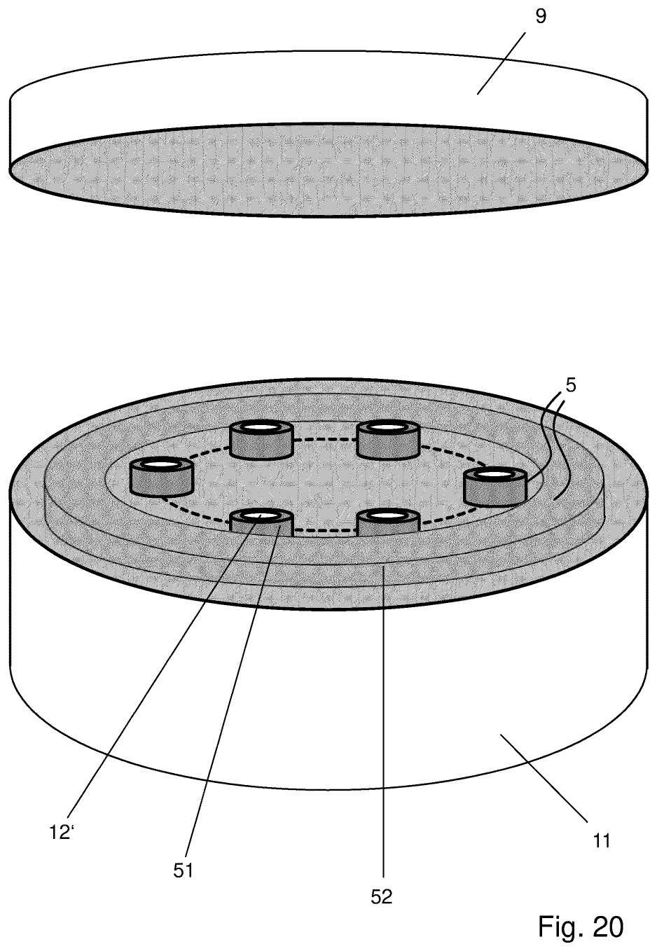

FIG. 20: a perspective view of a sealing point of the active valve according to a further embodiment,

FIG. 1A shows a schematic sectional view of an injector according to the invention, which clearly shows the structure of the injector 1.

The injector 1 comprises a fuel feed line 2, through which the fuel is supplied to the injector 1, an actuator unit (exemplary comprising a coil 8 with electrical connection, an armature 7, an armature rod 13 (optional), an armature counterpart 26, a housing 20, a non-magnetic bypass ring 22 and an iron return 25) for active actuation of a guided valve needle 9 (configured as a plate in FIG. 1) pretensioned via a valve spring 10. 1), which blocks or releases a throttle cross-section of the openings 12 in a valve needle counterpart 11 and a throttle cross-section (of the openings 19) in the valve needle 9 via one or more sealing elements 5 between valve needle counterpart 11 and valve needle 9 (by means of active valve 3), a passive valve 4 located downstream of the active valve 3 (comprising a passive valve insert 15, a passive valve rod 16 (optional), a passive valve guide 31 and a passive valve spring 14), which blocks or releases a throttle cross-section (defined by openings 34), and an injection cap 23 with a throttle cross-section (defined by openings 33) which deflects the fuel jet into the combustion chamber with a defined orientation during injection.

Armature rod 13 and armature 7 can be configured as a one-part or two-part or multi-part assembly. The components can be connected to each other (e.g. by force fit, form fit), but do not have to be connected to each other (see FIG. 6). The same applies to the passive valve insert 15 and the rod 16 interacting with the passive valve insert (see FIG. 7).

FIG. 1B shows several diagrams of the basic behavior of the injector 1 during an injection.

### Opening Phase:

FIG. 1B shows the basic behavior of the injector 1 during an injection. The exact course differs depending on the configuration of the active and passive valve.

In the initial position (see FIG. 1B and 2) at time t_O at bottom dead center (BDC) of the cylinder piston, the valve needle 9 and passive valve insert 15 are pressed by the pretensioned valve spring 10 or passive valve spring 14 into their respective upper stop 27 on the sealing element of the valve needle 9 or the sealing edge of the passive valve 29 and close the throttle points 12 and 19 or 34, which connect the needle chamber with the valve chamber or the valve chamber with the injection chamber in the open state. The pressure in the injector 1 up to the scaling element 5 corresponds to the pressure in the fuel feed line 2, the pressure in the combustion chamber and in the injection chamber corresponds to the boost pressure during the intake phase of the cylinder piston, in which fresh air is drawn into the combustion chamber via the intake valves. The pressure in the valve chamber corresponds approximately to the combustion chamber pressure and depends, among other things, on the configuration of the passive valve spring 14, the pressure in the combustion chamber during the phase in which the hot combustion gases are expelled via the exhaust valves of the combustion chamber and any preceding injection. The functional diagram below is simplified and does not take into account the change in charge due to the opening and closing of the inlet and outlet valves of the combustion chamber.

At time t_1 (see FIG. 1B), a voltage signal is applied to the coil 8 of the actuator via the electrical contacts so that the current in the electrical circuit increases to a defined final level. The current-carrying coil 8 induces a magnetic field in the actuator, the magnetic field lines 35 of which spread out in a torus shape around the coil 8 (see FIGS. 1 and 3). The magnetic field 35 builds up a magnetic force in the working air gap 23 between armature 7 and armature counterpart 26, wherein at time t_2 the armature 7 with armature rod 13 is attracted to the armature counterpart 26 in the opening direction as soon as the magnetic force exceeds the closing force (signed sum of the preload force of the valve spring 10 and pressure forces on armature 7 and valve needle 9). The build-up of the magnetic field and thus the magnetic force is delayed by eddy currents in the iron parts of the magnetic circuit. The armature 7 is in constant contact with the valve needle 9 via the armature rod 13 during the initial opening phase due to the preload of the valve spring 10, so that the valve needle 9 moves uniformly with the armature 7 or the armature rod 13.

As soon as the previously compressed, clastic sealing element 5 between valve needle 9 and valve needle counterpart 11 is no longer in simultaneous contact with the end faces of valve needle 9 and valve needle counterpart 11 at time t_3, the connection between the needle chamber and valve chamber is released so that the fuel flows through the cross-sections 12 and 19 from the needle chamber into the valve chamber. This increases the pressure in the valve chamber. As soon as the pressure difference from the valve chamber to the injection chamber corresponds to a force difference on the passive valve insert 15 equal to the preload force of the passive valve spring 14, the passive valve 4 opens, i.e. the passive valve insert 15 moves away from the sealing edge 34 and releases the connection between the valve chamber and the injection chamber so that fuel flows from the valve chamber into the injection chamber (see FIG. 3). This purely passive switching behavior of the passive valve 4 occurs if, for example, the passive valve rod 16 is not present (see FIG. 5) or is shortened in length in such a way that the passive valve 4 opens due to the pressure conditions before the valve needle 9 comes into contact with the passive valve insert 15.

However, the length of the passive valve rod 16 can be configured so that the switching of the passive valve 4 is not (purely) pneumatic/hydraulic, but (also) mechanical, in that the valve needle 9 comes into contact with the passive valve rod 16 and moves the passive valve insert 15 in the opening direction before the pressure forces would lead to the opening of the passive valve 4, or comes into contact at such a time that a combined mechanical/pneumatic opening takes place (see FIG. 3). In order to avoid geometric overdetermination, the length of the passive valve rod 16 can be selected so that there is a small valve gap 17 between the valve spring 9 and the passive valve rod 16 when both valves 3, 4 are closed (see FIG. 1A). In this case, the passive valve 4 is switched to mixed passive/active.

If armature rod 13, passive valve rod 16, passive valve insert 15 and valve needle 9 are not firmly connected to each other (e.g. form fit, force fit), they will continue to move due to inertia as soon as armature 7 hits its lower stop 24 until valve needle 9 or passive valve insert 15 hit their own lower stop 28, 30 (see FIG. 1A and 4). Subsequently, valve needle 9 and passive valve insert 15 as well as passive valve rod 16 may bounce and spring back until a mid-stationary equilibrium of mechanical and pneumatic/hydraulic forces is established and the gaps (see FIG. 4) between the components caused by the lift-off are closed again by contact between the components.

Opening the passive valve 4 leads to an increase in pressure in the injection chamber. The fuel continues to flow downstream through the opening(s) 33 in the injection cap 32 into the combustion chamber (see FIGS. 3 and 4). The injection cap 32 is configured in such a way that the flow is introduced into the combustion chamber in a defined state (jet orientation, inlet impulse, jet pattern, etc.). The open state of valve needle 9 and passive valve insert 15 is maintained during the entire remaining flow phase. The current level can be reduced (e.g. by a PWM voltage signal) as soon as the valve needle 9 is fully open and a possible bounce does not lead to the valve needle 9 closing. During injection, the engine cylinder is in the compression phase so that the combustion chamber pressure rises steadily.

### Closing Phase:

To end the blow-in process, the power supply is terminated by the control unit so that the current through the coil 8 is reduced to zero at time t_4 (see FIG. 1B). Due to the eddy currents, the magnetic force is also reduced with a time delay. As soon as the magnetic force is less than the sum of the closing force of the valve spring 10 and the pneumatic/hydraulic forces on the valve needle 9 and the armature 7, the needle 9 and armature 7 begin to close uniformly (time t_5). If the upstream end of the valve needle 9 approaches the valve needle counterpart 11 so closely that the sealing element 5/the sealing elements 5 simultaneously come into contact with the valve needle 9 and the valve needle counterpart 11 again, the connection between the needle chamber and the valve chamber is separated again and the fuel flow from the needle chamber into the valve chamber is interrupted (time t_6). This causes the pressure in the valve chamber to drop.

When the pressure difference from the valve chamber to the injection chamber corresponds to a force difference on the passive valve insert 15 equal to the spring force of the passive valve spring 14, the passive valve insert 15 moves back into its closed position at the sealing edge on the upper passive valve stop 29 and is pressed against the sealing edge by the increasing pressure in the combustion chamber and thus in the injection chamber, so that the fuel connection between the valve chamber and injection chamber is interrupted (possibly after a phase of bouncing of the passive valve insert 15 at the sealing edge) (points in time t_6-t_7). The injection process is now complete (see FIG. 2).

If the passive valve insert 15 is firmly connected to the valve needle 9 (see FIG. 7), the forces on the valve needle 9 (e.g. valve spring 10, pressure forces) also determine the closing of the passive valve insert 15. In this case, the passive valve spring 14 is not necessary.

During the further compression phase (see FIG. 1B) of the combustion chamber up to top dead center (TDC) in the period t_7-t_8, the air-fuel mixture in the injection chamber is compressed, while it expands in the subsequent expansion phase (period t_8-t_9). (The further interim increase in combustion chamber pressure due to combustion is not shown here in simplified form).

If the pressure in the combustion chamber drops to such an extent that the difference between the pressure forces on the passive valve insert 15 corresponds to the preload force of the passive valve spring 14 (time t_9), the passive valve insert 15 opens again briefly so that some of the fuel in the valve chamber escapes into the combustion chamber. This process depends on the spring force of the passive valve spring 14 and may not occur at all or may occur repeatedly (time period t_9-t_10).

In alternative configuration, e.g. with a passive valve insert firmly connected to the valve spring (see FIG. 7), this behavior also depends on the forces acting on the valve needle 9.

In the following figures, only the components that are of particular interest for the respective figure are highlighted with a reference symbol.

FIG. 2 shows a schematic sectional view of the injector 1 according to the invention in an initial state with closed valves 3, 4. It can be seen that both the active valve 3 and the passive valve 4 are in a closed state and there is no flow connection from the fuel feed line 2 to the injection cap.

FIG. 3 shows a schematic sectional view of the injector 1 according to the invention in an open state with open valves 3, 4. In addition, the flow 36 of the gaseous fuel through the injector 1 is shown by means of two continuous lines. It can be seen that the active valve 3 and the passive valve 4 are both in the open position and that there is a flow connection from the fuel supply 2 to the injection cap 32.

FIG. 4 shows a schematic sectional view of the injector 1 according to the invention in an open state with open valves 3, 4 and a respective gap between valve needle 9 and armature rod 13 as well as between valve needle 9 and insert 15 of the passive valve 4. In the maximum open position, both the valve needle 11 and the insert 15 of the passive valve 4 are retracted so far that there is no longer any contact between the valve needle 11 and the armature rod 13 as well as the valve needle 11 and the passive valve rod 16. The pressure differences or the flow of the gaseous fuel pushes the valve needle 11 or the passive valve insert 15 into its maximum open position.

FIG. 5 shows a schematic sectional view of the injector 1 according to the invention according to a further embodiment without passive valve rod 16. The passive valve 4 is opened exclusively by a pressure difference upstream and downstream of the passive valve insert 15. The passive valve 4 switches solely by the applied pressure forces after the valve needle 9 opens. Closing is also controlled purely passively.

FIG. 6 shows a schematic sectional view of the injector 1 according to the invention according to a further embodiment, in which the armature 7 is connected directly to the valve needle 9 via the armature rod 13. The lower stop can be made either via the armature 7 or the valve needle 9.

FIG. 7 shows a schematic sectional view of the injector 1 according to the invention according to a further embodiment, in which the valve needle 9 is connected directly to the insert 15 of the passive valve 4 via a rod-like element 16. Accordingly, the passive valve 4 can also be switched actively and no longer combined active-passive as shown in previous embodiments.

FIG. 8 shows a schematic sectional view of the injector 1 according to the invention according to a further embodiment, in which the valve needle 9 is connected to both the insert 15 of the passive valve 4 and the armature rod 13. Here too, the passive valve 4 is thus switched actively and no longer combined active-passive or only passive.

FIG. 9 shows two schematic sectional views of the injector 1 according to the invention arranged side by side according to a respective further embodiment, in which the rod-like elements 13, 16 are connected (left-hand representation) or not connected (right-hand representation).

In the left-hand illustration, the armature 7 is firmly connected to the rod-like element 13 or is even formed in one piece. The passive valve insert 15 is also firmly connected to the rod-like element 16 or is formed in one piece.

In the right-hand illustration, the respective rod-like element 13, 16 is not firmly connected to the armature 7 or the passive valve insert 15. As can be seen in FIG. 9, the passive valve rod 16 is arranged so that it can move in the longitudinal direction of the injector 1 and is guided laterally. The lateral guidance of the armature rod 13 is achieved by passing through the opening of the valve needle counterpart.

FIG. 10 shows a schematic sectional view of the injector 1 according to the invention according to a further embodiment, in which tolerance compensation is achieved by an elastic stop 38 of the armature 7. In this case, it can be provided that the passive valve insert 15 rests against the valve needle 9 in the initial state with the passive valve rod 16 due to the tolerance compensation of an elastic upper stop 38 of the armature 7.

FIG. 11 shows a schematic sectional view of the injector 1 according to the invention according to a further embodiment, in which tolerance compensation is achieved by an elastic intermediate piece 18 between the insert 15 of the passive valve 4 and the valve needle 9. The passive valve insert 15 can rest against the valve needle 9 with the passive valve rod 16 in the initial state due to the tolerance compensation of an elastic intermediate piece 18 between the passive valve insert 15 and the valve needle 9. The force transmission from the valve needle 9 to the passive valve insert 15 is less abrupt at the beginning.

FIG. 12 shows a schematic sectional view of the injector 1 according to the invention according to a further embodiment, in which elastic damping elements 39 are provided to reduce or prevent bouncing. In this way, bouncing of armature 7, valve needle 9 and passive valve insert 15 during opening and closing can be reduced or even prevented.

FIG. 13 shows a schematic sectional view of the injector 1 according to the invention according to a further embodiment, in which elastic damping elements are provided to reduce or prevent bouncing. In this way, bouncing of armature 7, valve needle 9 and passive valve insert 15 during opening and closing can be reduced or even prevented. FIG. 14 shows a schematic sectional view of the injector 1 according to the invention according to a further embodiment, in which the armature 7 has no contact with the valve needle 9 in a closed position of the active valve 3.

In the closed state, the armature 7 is without contact to the valve needle 9 (e.g. via a restoring force of another armature spring 40). The armature 7 is pressure-balanced at the start of energization. The armature 7 can therefore initially accelerate strongly and hits the valve needle 9 with a high impact impulse in order to open it quickly or to overcome high closing forces.

FIG. 15 shows a schematic sectional view of the injector 1 according to the invention according to a further embodiment with an opening movement of the valve needle that is directed against the direction of flow of the gaseous fuel.

All the versions shown so far include an outward-opening active valve 3 and an outward-opening passive valve 4. The version shown in FIG. 15 is a variant with an inward-opening active valve 3. The passive valve 4 switches completely passively due to the applied pressure forces and the set spring force of the passive valve spring 14.

There is no armature rod and no passive valve rod. Valve needle 9 and armature 7 are connected to each other (e.g. form fit, force fit). The previous flow cross-sections in the valve needle counterpart and the valve needle 12 and 19 merge to form a cross-section 12′ in the valve needle counterpart 11.

When the injector 1 is activated and the magnetic field is formed, the armature 7 together with the valve needle 9 is pulled upwards towards the armature counterpart 26 so that the cross-section 12′ is released. The pressure build-up in the valve chamber causes the passive valve 4 to open. When the valve is switched off, the armature/valve needle assembly closes again and blocks the cross-section 12′. The passive valve 4 closes again after pressure equalization between the valve chamber and the injection chamber due to the passive valve spring 14.

However, just as in all other embodiments, a seal is also created here between the valve needle 9 and the valve needle counterpart 11 with the aid of an elastic sealing element 5.

FIG. 16 shows a perspective view of a scaling point of the active valve 3 according to a first embodiment. It is clear to the skilled person that the specific design of the scaling point of the active valve 3 (shown as an example in FIGS. 16-20) can be used with any injector configuration. For example, it is irrelevant whether the downstream passive valve 4 is only moved out of its closed position by means of a pressure difference or also by mechanical force.

According to the implementation shown in FIG. 16, the through surfaces 12 through the valve needle counterpart 11 are located outside the sealing islands 51 on the valve needle 9, although a reverse configuration is also possible. The openings 12 in the valve needle counterpart 11 are therefore arranged radially further outwards than the openings 19 in the valve needle 9. This means that when the two contact surfaces are in contact with each other, the respective opening cross-sections do not overlap and can be sealed off from each other with the aid of correspondingly arranged sealing elements 5. For the openings 19 of the valve needle 9, for example, respective inner sealing elements 51 are provided which surround the circumference of each cross-section of an opening 19 so that a seal is created when it is placed on the valve needle counterpart 19. The openings 12 of the valve needle counterpart 11 are sealed with the aid of a single elastic outer sealing element 52, in whose area defined by the inner circumference all openings 12 of the valve needle counterpart 11 are arranged.

When closed, the inner sealing elements 51 prevent flow through the throttle surfaces 19, whereas the outer sealing element 52 prevents flow around the valve needle when closed. Without the outer sealing element 52, undesirable leakage could otherwise occur through a gap between the valve needle and the housing.

In the present case, it is clear to the person skilled in the art that through throttling surfaces can be configured as bores, slots etc. and that the shape can be freely selected. It is also possible that the sealing elements 51, 52 (inside and outside) can be configured individually or connected to each other.

Due to their elastic shape, the sealing elements 51, 52 also have a damping effect against bouncing, which is further advantageous when the active valve 3 is actuated. Furthermore, it may be provided that the armature rod 7 is closely guided in the central bore 45 of the valve needle counterpart 11.

It is also possible for the end faces of the valve needle and valve needle counterpart to be planar or curved or otherwise shaped. Of course, it is advantageous if the shape of the valve needle 9 and valve needle counterpart 11 are matched to each other.

FIG. 17 shows a perspective view of a sealing point of the active valve according to a further embodiment. The outer sealing elements 52 for sealing the openings in the valve needle counterpart 11 are arranged directly on the valve needle counterpart, e.g. via respective scaling islands around corresponding through bores 12. However, it is equally possible to arrange a single, large scaling ring (analogous to FIG. 16) on the valve needle counterpart 11, in the inner circumference of which all openings 12 of the valve needle counterpart 11 are arranged.

FIG. 18 shows a perspective view of a sealing point of the active valve according to a further embodiment. In the present case, each opening 12, 19 in the valve needle counterpart 11, as well as in the valve needle 9, has a respective elastic sealing ring and a further elastic sealing ring with an enlarged diameter is additionally provided on the valve needle 9, in the inner circumference of which all openings 12, 19 are located in a closed state. In addition to its function as a sealing element, this outer sealing element on the valve needle 9 can also act as an additional damping element.

FIG. 19 shows a perspective view of a sealing point of the active valve according to a further embodiment, in which the individual sealing elements 51, 52 are connected to each other via webs 53 and thus form a one-piece “large” sealing element.

FIG. 20 shows a perspective view of a sealing point of the active valve according to a further embodiment, which can be used, for example, for the embodiment shown in FIG. 15. Unlike in the previous figures, the lower part is fixed in the injector housing so that its passages 12′ can be optionally closed or opened by the movable valve needle 9 shown above. The large outer sealing ring 52 is not absolutely necessary, but increases the fatigue strength of the seal and provides a further positive damping effect that reduces bouncing.

1. Injector for injecting gas, comprising:
a fuel feed line for introducing a gaseous fuel which is under high pressure,
an actively switchable active valve, which is configured to be in a closing state or a releasing state in order to selectively permit or interrupt a flow connection from the fuel feed line to an area downstream of the active valve, and
a passive valve, which is arranged downstream of the active valve and can be passively switched into a closing state or releasing state by different pressure ratios prevailing upstream and downstream and/or can be brought into a closing state or releasing state by contact with a movable part of the active valve,
wherein
in a closed state of the active valve, at least one sealing surface of the active valve is sealed by an elastic sealing element.

2. Injector according to claim 1, wherein, in a closed state of the passive valve, a sealing surface of the passive valve is sealed by a rigid sealing element.

3. Injector according to claim 1, wherein the active valve comprises an armature which is movable in the longitudinal direction of the injector, which armature is movable out of its rest position depending on a magnetizable coil so as to urge a valve needle out of its closed position, preferably wherein the injector further comprises a valve spring for urging the valve needle into its closed position.

4. Injector according to claim 3, further comprising a valve needle counterpart which is rigidly arranged in the injector and which serves for selectively placing a valve needle in order to close at least one opening present in the valve needle counterpart, wherein in a mounted state of the valve needle at least one elastic sealing element which seals the at least one opening is arranged in the intermediate space between the valve needle counterpart and the valve needle.

5. Injector according to claim 4, wherein the valve needle counterpart is arranged upstream of the valve needle.

6. Injector according to claim 4, wherein a valve spring for urging the valve needle into its closed position is arranged on the side of the valve needle facing away from the valve needle counterpart and is located downstream of the valve needle.

7. Injector according to claim 3, wherein the passive valve is arranged downstream of the valve needle and is urged into its closing position via a passive valve spring element in the direction of the valve needle.

8. Injector according to claim 3, wherein when the active valve is actuated, which leads to a movement of the valve needle into the open position, the opening movement of the valve needle exerts a mechanical force effect on the passive valve for transferring it into the open position.

9. Injector according to claim 3, wherein in a closed position of the active valve as well as the passive valve, a gap is formed between the side of the valve needle facing the passive valve and the side of the passive valve facing the valve needle, wherein this gap is dimensioned such that it is closed when the active valve is actuated, which leads to a movement of the valve needle into the open position, so that after this gap is closed by the continuation of the opening movement of the valve needle, a mechanical force is exerted on the passive valve to transfer it into the open position.

10. Injector according to claim 9, wherein an elastic intermediate piece is arranged in the gap in order to dampen the force acting on the passive valve.

11. Injector according to claim 3, wherein in a closed position of the active valve, the armature urging the valve needle out of its closed position is spaced apart from the valve needle, in order to receive a certain acceleration before contacting the valve needle during an opening process.

12. Injector according to claim 4, wherein the valve needle counterpart is arranged stationary in the injector and/or comprises at least one opening for passing the gaseous fuel, wherein the gaseous fuel is guided through the entire injector in such a way that the flow always extends inside or outside of pressure springs.

13. Injector according to claim 5, wherein the valve needle and/or the valve needle counterpart comprises at least one elastic sealing element on the side facing the valve needle counterpart or the valve needle in order to seal off, in a compressed state, at least one opening of the valve needle counterpart for passing the gaseous fuel from the at least one opening of the valve needle for passing the gaseous fuel.

14. Method for operating an injector according to claim 1, wherein, during an injection, a sound passage occurs at at least one point in the injector in order to achieve a decoupling from the combustion chamber to the injector, so that the injection rate is independent of the combustion chamber back pressure, wherein the sound passage occurs at the at least one opening in a valve needle counterpart and/or at at least one opening in the valve needle, which represent(s) throttling surfaces limiting the flow of the gaseous fuel.

15. Internal combustion engine with direct gas injection, comprising an injector according to claim 1.

16. Injector according to claim 1, wherein the injector is a hydrogen direct injector, wherein the actively switchable active valve is an active solenoid valve.

17. Injector according to claim 1 wherein the elastic sealing element includes a metal-elastomer seal.

18. Injector according to claim 2, wherein the rigid sealing element includes a metal-to-metal seal.

19. Injector according to claim 5, wherein a component of the armature element of the active valve includes a rod-like armature part that extends through an opening of the valve needle counterpart in order to contact the valve needle arranged on the downstream side of the valve needle counterpart during an opening movement of the active valve and to urge it into a releasing position.

20. Injector according to claim 8, wherein the mechanical force effect on the passive valve is exerted by means of a rod-like element arranged on the valve needle on a passive valve insert or between the valve needle and the passive valve insert.
